(19) United States
(12) Patent Application Publication
(10) Pub. No.: US 2008/0011804 A1
(43) Pub. Date: Jan. 17, 2008

(54) PILL SPLITTER WITH PROTECTED BLADE AND LOCKING ARM

(75) Inventors: Aidan Petrie, Jamestown, RI (US); Daniel Nelsen, Providence, RI (US); Max Lu, Kowloon (CN)

Correspondence Address: BARLOW, JOSEPHS & HOLMES, LTD., 101 DYER STREET, 5TH FLOOR, PROVIDENCE, RI, 02903, US

(73) Assignee: ITEM SOURCE LLC, PROVIDENCE, RI (US)

(21) Appl. No.: 11/776,338

(22) Filed: Jul. 11, 2007

Related U.S. Application Data
(60) Provisional application No. 60/806,952, filed on Jul. 11, 2006.

(51) Int. Cl. B26F 3/00

(52) U.S. Cl. 225/103; 206/528; 30/124

(57) ABSTRACT

The present invention provides a pill splitter that is designed for cutting pills in a relatively safe and reliable manner. The pill splitter includes a main body with a top housing and a bottom housing having a blade mounted thereto. The top housing has a slot defined therein for receipt of the blade. The top housing moves relative to the bottom housing between a protected position, unexposed blade, and a cutting position, exposed blade. In the protected position, the top housing resides in front of the blade to prevent a user from contacting the blade. In the cutting position, the blade is routed through the slot in the top housing thereby exposing a cutting edge thereof for cutting a pill.

### CROSS-REFERENCE TO RELATED APPLICATION

This application is related to and claims priority from earlier filed provisional patent application Ser. No. 60/806,952, filed Jul. 11, 2006.

### BACKGROUND OF THE INVENTION

The present invention generally relates to pill cutters or pill splitters. More specifically, the present invention relates to a pill splitter that can cut pills or tablets into smaller portions for proper dosing of a given medication.

In the medical industry, it is well known to provide pills for the delivery of medication. However, a given pill size may be too large for a desired dosage. As a result, it has become common to split or cut pills so they are smaller in size to better match the desired dosage. For example, if a 150 mg dosage of a medication is desired and only 100 mg pills or tablets are available, there is a desire to split one pill into 50 mg pill so it can be taken with a 100 mg pill so a 150 mg amount of medication can be delivered. Also, larger pills may be cut into smaller sizes to make them easier to take.

Pill splitting or cutting is very well known in the art. A pill can be split by hand with a knife but this is very dangerous. Various pill splitting devices have been created that better control this process. For example, various prior art devices include an exposed fixed blade that is mounted to a cover that closes down onto a pill that is fixed in place on a base plate. When the cover is closed, the blade comes down onto a pill to split it. These devices can be effective; however, they are still very dangerous in that it includes an exposed blade that can injure the user.

There have been a number of attempts in the prior art to provide a safer pill splitter. For example, published application Ser. No. 10/672,239 (Pub No. 2005/0067452) teaches a pill splitter that includes a sliding blade guard that retracts when the cover is closed to expose the blade when the cover is closed. This construction is complicated and expensive to manufacture and is also difficult to use.

In view of the foregoing, there is a desire to provide a pill splitter that is easy and inexpensive to manufacture yet is effective in protecting the blade when the cover is open. There is a desire for a pill splitter that more effectively and safely splits pills than prior art devices.

### SUMMARY OF THE INVENTION

An embodiment of the present invention preserves the advantages of prior pill splitters. In addition, it provides new advantages not found in currently available pill splitters and overcomes many disadvantages of such currently available pill splitters.

Generally, the present invention is a pill splitter used for dissecting items, such as pills, into smaller sizes or pieces. Specifically, the pill splitter consistently dissects pills in a reliable and safe manner. The pill splitter provides a user an effective mechanism for dissecting a pill while reducing the risk of personal injury due to contact with any sharp objects.

The pill splitter includes a main body with a top housing and bottom housing. A blade is mounted to the bottom housing for use in dissecting a pill. The top housing defines a slot for receipt of the blade when the top housing is moved relative to the bottom housing to expose the blade.

A lid is hingedly connected to the top housing. The lid provides a wedge for receipt within an aperture defined within the top housing. The lid provides a cushioning surface, such as a cushioning pad, to help secure the pill while it is being split. Also, a pill seat is integrally formed within the top housing to provide stability during cutting of a pill.

When the lid is in an open position, the blade is unexposed and a pill is placed in a pill seat. When the lid is in a closed position, a cushioning surface contacts a pill within a pill seat to prevent movement therein. At the same time, the wedge moves through the slot to allow for the movement of the top housing into the bottom housing. Subsequently, when the top housing actuates downward, the blade is exposed for cutting of a pill. After a pill is cut, the top housing is spring-bias to return to its original position.

A spring-bias locking arm is attached to the top housing to control the movement of the top housing relative to the bottom housing. The locking arm includes a flange that engages the wedge on the lid to move the locking arm. When the lid is open, the locking arm is at rest to prevent the movement of the top housing. When the lid is closed, the wedge engages the flange to clear the locking arm which allows for the movement of the top housing relative to the bottom housing.

In use, the top housing moves relative to the bottom housing between a protected position and a cutting position. In the protected position, the top housing resides in front of the blade to prevent a user from contacting the blade. In the cutting position, the blade is routed through the slot in the top housing thereby exposing a cutting edge thereof for cutting a pill.

It is therefore an object of the pill splitter to provide a reliable and safe mechanism for cutting a pill into smaller sizes.

It is a further object of the embodiment to provide the pill splitter that conceals a blade until the lid is in a closed position.

Another object of the embodiment is to provide the pill splitter that reduces the risk of personal injury to a user.

### BRIEF DESCRIPTION OF THE DRAWINGS

The novel features which are characteristic of the pill splitter are set forth in the appended claims. However, the pill splitter, together with further embodiments and attendant advantages, will be best understood by reference to the following detailed description taken in connection with the accompanying drawings in which:

FIG. 1 is a perspective view of a pill splitter of the present invention;

FIG. 2 is a perspective view of the pill splitter in FIG. 1 with the lid in an open position;

FIG. 3 is a perspective view of the pill splitter in FIG. 1 with the lid in an open position and the pill positioned within a pill seat;

FIG. 4 is a perspective view of the pill splitter in FIG. 1 with the lid in a closed position and the pill positioned within a pill seat prior to splitting;

FIG. 5 is a perspective view of the pill splitter in FIG. 1 with lid in a closed position and top housing actuated downward by user for splitting of the pill positioned within a pill seat;

FIG. 6 is a perspective view of the pill splitter in FIG. 1 with lid in an open position and pill split into pieces;

FIG. 7 is a perspective view of the pill splitter in FIG. 1 with lid and top housing in dashed lines and locking arm at rest;

FIG. 8 is a perspective view of the pill splitter in FIG. 1 with lid and top housing in dashed lines and locking arm engaged;

FIG. 9 is a top view of the pill splitter in FIG. 1 with the lid removed and top plate removed;

FIG. 10 is a bottom perspective view of the pill splitter in FIG. 1 with the bottom housing removed;

FIG. 11 is a bottom view of the pill splitter in FIG. 1 with the bottom cover removed; and

FIG. 12 is a perspective view of the bottom cover used in the pill splitter of FIG. 1.

### DETAILED DESCRIPTION OF THE PREFERRED EMBODIMENTS

The present invention solves the problems in prior art pill splitters by providing a new and unique construction for safe and effective cutting of pills. Generally, the present invention generally is a pill splitter 10 used for dissecting items, such as pills, into smaller sizes or pieces. Specifically, a pill splitter 10 dissects pills in a reliable and safe manner. The pill splitter 10 provides a user an effective mechanism for dissecting a pill while reducing the risk of personal injury due to contact with any sharp edges.

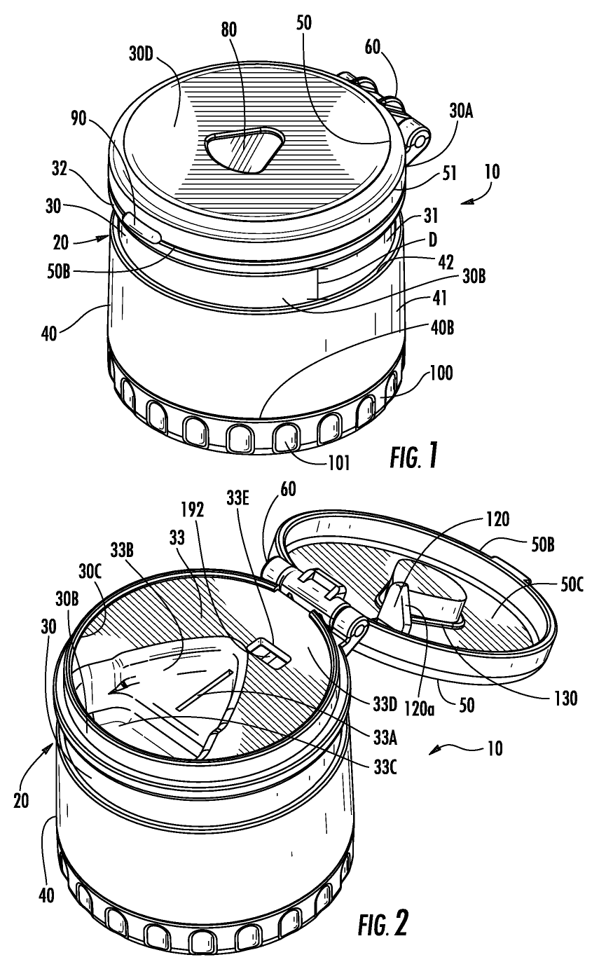

Referring now to FIG. 1, the pill splitter 10 of the present invention is shown in perspective view. The pill splitter 10 includes a main body 20 with a top housing 30 and a bottom housing 40. The main body 20 preferably has a cylindrical shape to provide a surface easily manipulated within a user's hand. The materials used in construction of the main body 20 are preferably plastics. However, any material that is durable and with sufficient strength for consistent cutting of pills is eligible for use.

The bottom housing 40 has a diameter preferably greater than the top housing 30 to facilitate movement of the top housing 30 relative to the bottom housing 40. However, the diameter of the top housing 30 may be greater than the diameter of the bottom housing 40. A side wall 41 depends from the circumference of the bottom housing 40 with a length sufficient to receive the top housing 30. The side wall 41 has sufficient thickness for withstanding the pressure when the top housing 30 engages the bottom housing 40.

The top housing 30 is configured to actuate upward and downward relative to the bottom housing 40. The top housing 30 has a side wall 31 depending from the circumference of the top housing 30 and having a length suitable for movement relative to the bottom housing 40. Also, the materials used within the side wall 31 of the top housing 30 may reduce friction to allow for free movement of the top housing 30 relative to the bottom housing 40.

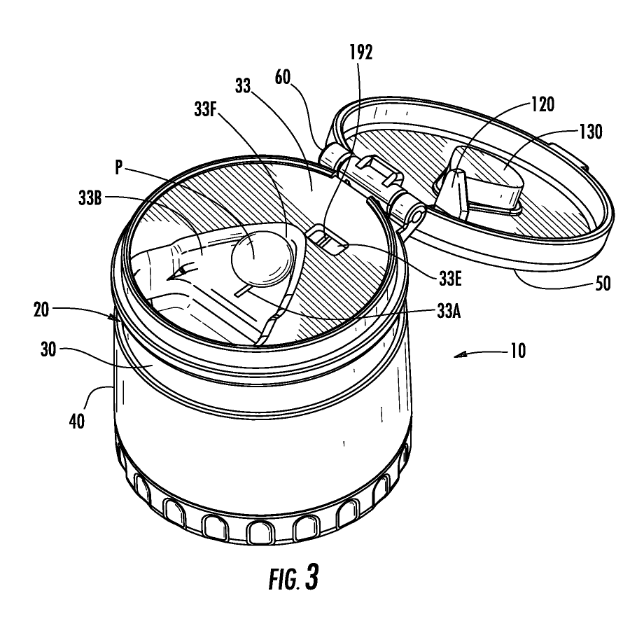

A lid 50 is provided that hingedly connects to the side wall 31 of the top housing 30. The lid 50 has a side wall 51 downwardly depending from the circumference thereof. A hinge 60 respectively mounts to an upper portion 30A of the top housing 30 and the side wall 51 of the lid 50. Preferably, the hinge 60 is mounted on the upper portion 30A of the top housing 30 opposite a pill seat 33B, which is shown in FIG. 2. The hinge 60 permits movement of the lid 50 from a closed position (FIG. 1) and into an open position (sees FIG. 2).

The top housing 30 further includes a ridge 32 positioned about an outer surface 30B of the top housing 30 for engagement with the bottom housing 40. Preferably, the ridge 32 is positioned along the upper portion 30A of the top housing 30, and below the lid 60, for engagement with the outer peripheral edge 42 of the bottom housing 40. The outer peripheral edge 42 of the bottom housing 40 terminates at a distance D from the ridge 32 to provide a range of movement for the top housing 30 relative to the bottom housing 40. In addition, an outer peripheral edge 50B on a bottom surface 50C of the lid 50 rests upon the ridge 32 when the lid 50 is in a closed position (FIG. 1) to provide stability while cutting the pill.

To further facilitate the movement of the lid 50, the lid 50 has a top surface 50D with a region 80, such as a triangular shape. The region 80 is respectively positioned above a pill when the lid 50 is in a closed position (FIG. 1). The region 80 indicates an area where user pressure can be applied to facilitate the cutting of a pill. In one embodiment, the region 80 is scripted with the word “PUSH”. This region 80 is provided to assist the user in operation of the device 10, however, it is optional.

In addition, the lid 50 has an integrally formed tab 90 protruding horizontally from the side wall 51. The tab 90 is sized for engagement with the tip of a user's finger, to facilitate manipulation of the lid 50. In one embodiment, the tab 90 is located opposite the hinge 60.

A bottom cover 100 encloses an opening defined within a lower portion 40B of the bottom housing 40 to provide an area for storage. The bottom cover 100 is threadably attached to the bottom of the device 10. In addition, the bottom cover 100 has knurling 101 disposed along the outer surface thereof to facilitate rotation thereof. The knurling 101 are positioned along the outer surface to enhance a user's grip on the pill splitter 10.

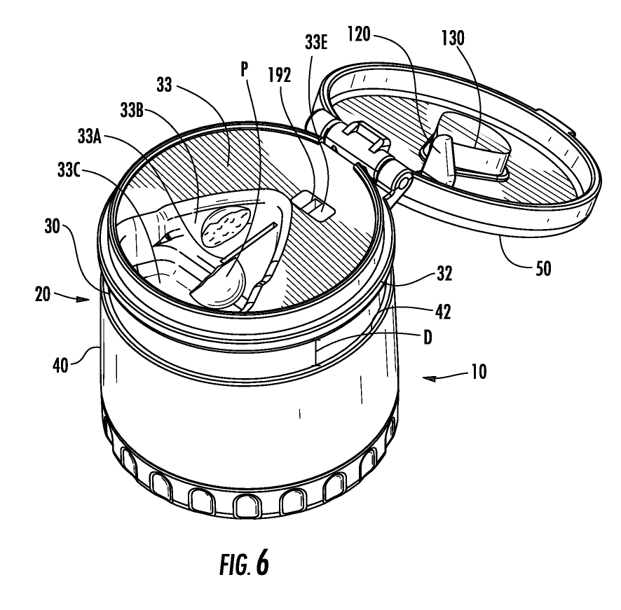

Referring to FIG. 2, a perspective view of a pill splitter 10 of FIG. 1 is shown with the lid 50 in the open position. The top housing 30 has a top plate 33 dispersed along an inner surface of the upper portion 30A of the top housing 30. In a preferred embodiment, the top plate 30 extends along an inner peripheral edge 30C of a defined opening within the upper portion 30A of the top housing 30. Blade 110 is fixed to the bottom housing 40. The top plate 33 defines a slot 33A for slidable movement of a blade 110 (as seen in FIG. 6) therethrough when the top housing 30 moves downwardly towards the bottom housing 40. The slot 33A is respectively positioned above the blade 110 to allow free movement of the blade 110 through the top plate 33 and into contact with a pill.

Also, the pill seat 33B is integrally formed within an outer surface 33D of the top plate 33 and positioned about the slot 33A to provide stability to a pill during cutting. For example, pill seat 33B has a triangular shape recessed into the top plate 33. The volume of the pill seat 33B is sufficient for pills with different shapes and sizes. Also, other items of similar size can be positioned within the pill seat 33B for cutting. When cutting multiple pills, the outer surface of the top plate 33 is provided with an integrally formed well 33C continuous with the pill seat 33B. The well 33C can be used for temporary storage of additional pills, pill pieces, or other items.

A bottom surface 50C of the lid 50 provides a downwardly protruding wedge 120 with a cam surface 120A. The wedge 120 is sized to move through an aperture 33E defined within the top plate 33. The wedge 120 preferably has a triangular shape, such as a right angled triangle, with the longest side positioned to the right and one side of the wedge 120 attached to the bottom surface 50C of the lid 50. It should be noted that the wedge 120 may be a shape other than triangular and the longest side maybe positioned to the left.

The bottom surface 50C of the lid 50 provides a downwardly protruding cushioning surface 130, such as a cushioning pad made of foam, felt or rubber. The cushioning surface 130 is also respectively positioned below the region 80 on the top surface 50D. When the lid 50 is in a closed position (FIG. 4), the cushioning surface 130 occupies a volume within the pill seat 33B to contact a pill. Other materials, such as foam, may be used in construction of the cushioning surface 130 to provide downward pressure on a pill in the pill seat 33B during cutting. The cushioning surface 130 has a triangular shape that is sized according to an outline of the region 80.

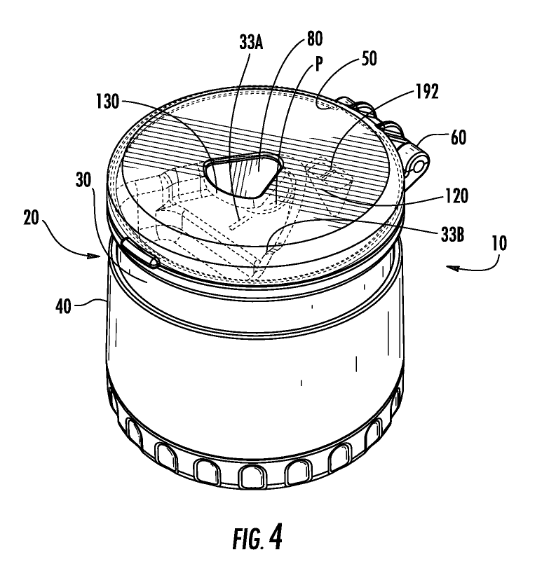

In operation, referring now to FIG. 3, the pill splitter of FIG. 1 is shown with the lid 50 in the open position. For proper use, when the lid 50 is open, a pill P is positioned within a forward portion 33F of the pill seat 33B and positioned above the slot 33A for cutting. Of course, the pill P may be positioned anywhere above the slot 33A and within the volume of the pill seat 33B.

Referring to FIG. 4, the pill splitter of FIG. 1 is shown with the lid 50 in a closed position and interior parts shown in broken lines for illustration purposes. The pill P is engaged by the cushioning surface 130 and positioned within the pill seat 33B above the slot 33A. At this time, the wedge 120 is moved through the aperture 33E to permit movement of the top housing 30 relative to the bottom housing 40 as will be described in detail below.

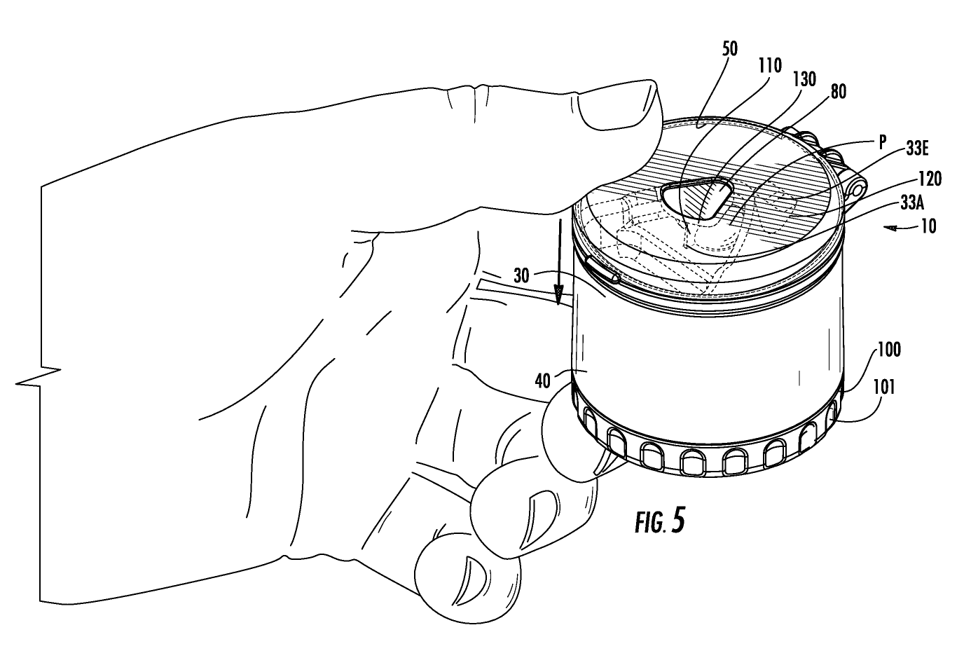

Referring to FIG. 4, the pill splitter 10 of FIG. 1 is shown in a perspective view with the lid 50 in a closed position and the ridge 32 of the top housing 30 contacting the outer peripheral edge 42 of the bottom housing 40. In FIG. 5 the user's hand or finger exerts downward pressure on the top housing 30 to move the top housing 30 relative to the bottom housing 40. For purposes of illustration, the user's hand is depressing the lid 50 and side wall 31 of the top housing 30. Alternatively, the user, with one hand, may provide pressure to the region 80 labeled “PUSH” while, with the other hand, holding the knurling 101 dispersed on the bottom cover 100 to facilitate the cutting of the pill P.

As a result of the downward movement of the top housing 30 relative to the bottom housing 40, the blade 110 travels upwardly through the slot 33A. When the blade 110 moves through the slot 33A, it cuts the pill P, positioned within the pill seat 33B, in an upward direction. The blade 110 cuts through the pill P until either the blade 110 is fully extended through the slot 33A or the cushioning surface 130 is contacted. The blade 110 is made of steel or other materials that provide sufficient strength to cut a plurality of pills before replacement.

Referring to FIG. 6, a pill splitter 10 of FIG. 1 is shown with the lid 50 in the open position. With the top housing 30 back in its original position, a distance D between the ridge 32 and the outer peripheral edge 42 of the bottom housing 40, the blade 110 recedes back through the slot 33A. Also, when in its original position, the wedge 120 retracts from the aperture 33E to prevent movement of the top housing 30 relative to the bottom housing 40. In addition, the cushioning surface 130 no longer contacts the pill P or fills a volume of the pill seat 33B. Now, the user can remove the pieces of the pill P from the pill seat 33B. Alternatively, the pieces of the pill P are moved away from the pill seat 33B and into the well 33C for temporary storage.

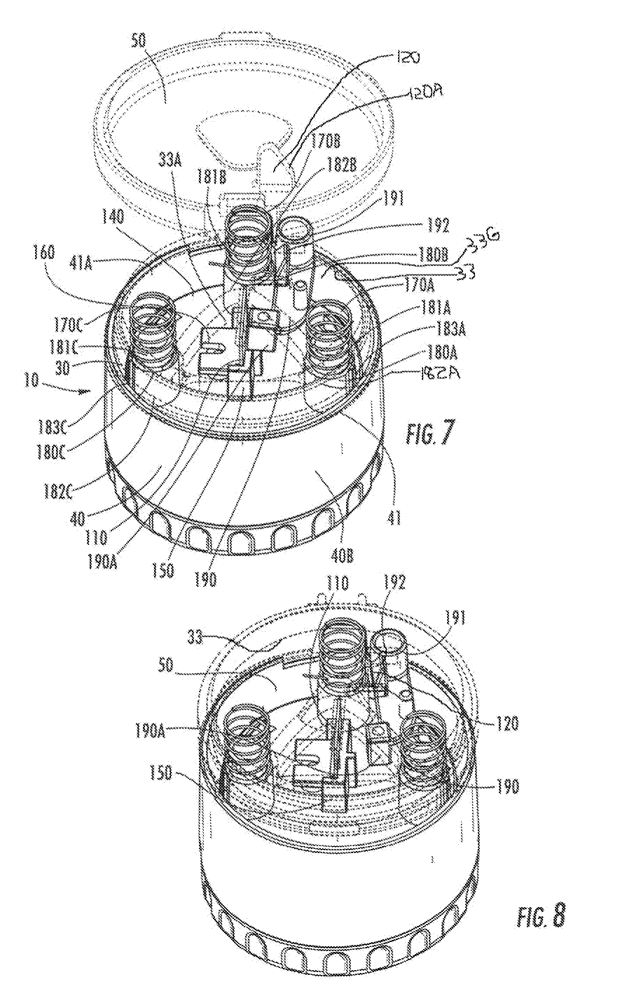

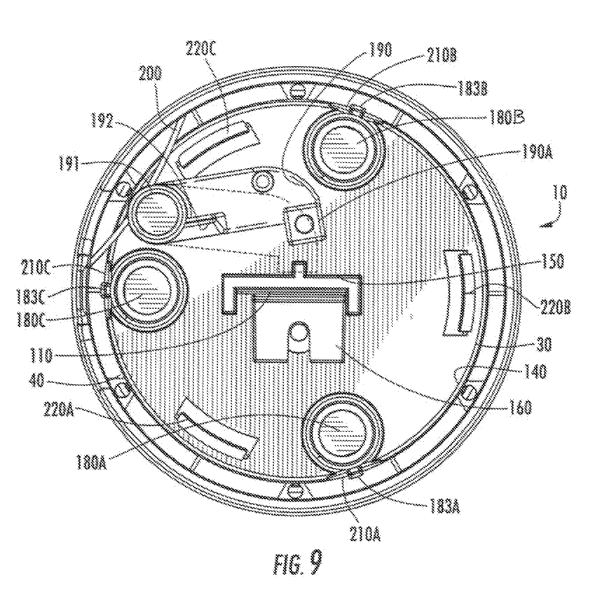

The safety control of movement of blade 110 is shown in detail in FIGS. 7-9. Referring to FIG. 7, a perspective view of the pill splitter 10 of FIG. 1 is shown with the lid 50 and top housing 30 in dashed lines to reveal an interior of the bottom housing 40. The bottom housing 40 has a floor plate 140 positioned along an inner surface 41A of the side wall 41 of the bottom housing 40. The floor plate 140 is positioned, preferably, on the bottom portion 40B of the inner surface 41A to provide sufficient distance from the top housing 30. As seen in FIG. 9, in one embodiment, the floor plate 140 has at least one latching attachment 220A-C for securing the floor plate 140 within an opening 40C of the bottom housing 40.

Referring back to FIG. 7, the blade 110 is located within a blade holder 150 mounted to the floor plate 140 and thereby fixed to bottom housing 40. The blade 110 is respectively positioned below the slot 33A. In an embodiment, the blade 110 is stabilized within the blade holder 150 by a grip 160. The grip 160 is adjustably connected to the floor plate 140 and positioned against the blade 110 to provide stability and strength to the blade 110 during cutting of a pill.

The top housing 30 is spring-biased to actuate up and down relative to the bottom housing 40. At least one spring 170A-C is employed between the top housing 30 and the bottom housing 40. The spring 170A-C is positioned over a portion of a post 180A-C attached to the floor plate 140. In a preferred embodiment, three springs 170A-C are positioned over three posts 180A-C. The top portion 181A-C of the post 180A-C has a diameter smaller than the spring 170A-C. The bottom portion 182A-C of the post 180A-C has a diameter similar to the spring 170A-C for seating the spring 170A-C. While coil springs are preferred for this purpose, any spring-biasing members may be used.

In addition, at least one rail 183A-C is defined on the bottom portion 182A-C of at least one post 180A-C attached to the floor plate 140. The rail 183A-C provides stable movement of the top housing 30 relative to the bottom housing 40. For example, the rail 183A-C prevents the twisting of the top housing 30 relative to the bottom housing 40. In a preferred embodiment, three rails 183A-C are defined on three posts 182A-C but it is understood that more than or less than three rails may be used.

Referring to FIG. 7 and FIG. 8, a spring-biased locking arm 190 is pivotally connected to a bottom surface 33G of the top plate 33. A pivot post 191 is attached to the bottom surface 33G. The pivot post 191 facilitates the movement of the locking arm 190 from an at rest position (FIG. 7) that prevents movement of the top housing 30, and to an engaged position (FIG. 8) that allows movement of the top housing 30.

The locking arm 190 includes a flange 192 that receives camming surface 120A of wedge 120 on the lid 50 to move the locking arm 190 when the lid 50 is in a closed position. The flange 192 extends upward from the locking arm 190 for engagement with camming surface 120A of wedge 120. When the locking arm 190 is at rest (FIG. 7), a block 190A on the distal end of the locking arm 190 is positioned between the blade mount 150 and the top plate 33 to prevent the downward movement of the top housing 30. When the camming surface 120A of wedge 120 engages the flange 192, block 190A of locking arm 190 is cleared from between the blade mount 150 and the top housing 30. Thus, the block 190A moves away from the blade mount 150 to allow the free movement of the top housing 30 relative to the bottom housing 40. As a result, the blade 110 is free to travel through slot 33A.

Referring to FIG. 9, a top view of the pill splitter 10 in FIG. 1 is shown with the lid 50 and the top plate 140 removed. The locking arm 190 is spring-biased. A camming spring 200 is positioned about the pivot post 191 to spring-bias the locking arm 190 to an at rest position where block 190A is resting between holder 150 and top housing 30 to lock blade 110. As shown in FIG. 9, the locking arm 190, in dotted lines, contacts the blade holder 150 in the at rest position to prevent movement of the top housing 30. When the camming surface 120A of wedge 120 engages the flange 192, the locking arm 190, in sold lines, is cleared from between the blade mount 150 and the top housing 30. When the camming surface 120A of wedge 120 no longer engages the flange 192, the locking arm 190 returns to its at rest position by use of spring 200.

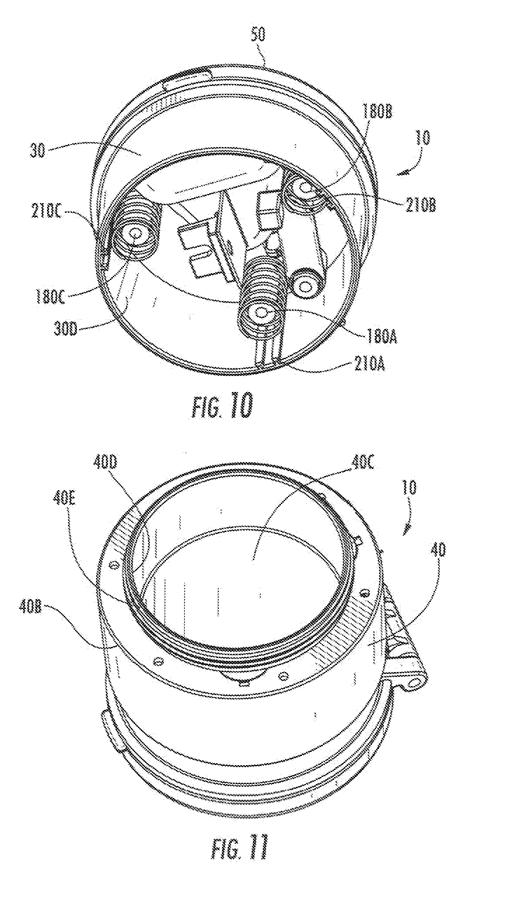

Referring now to FIG. 10, a bottom perspective view of the pill splitter 10 in FIG. 1 is shown without the bottom housing 40 and blade holder 150. An inner surface 30D of the top housing 30 has at least one rail guide 210A-C defined therein which engages at least one rail 183A-C defined within the bottom portion 182A-C of the post 180A-C for keying purposes. When slidably engaged, the rail 183A-C and rail guide 210A-C facilitate steady movement of the top housing 30 relative to the bottom housing 40 for a predefined range. In particular, the rail 183A-C and rail guide 210A-C prevent the twisting or rotation of the top housing 30 relative to the bottom housing 40. In one embodiment, there are three rails 183A-C and three rail guides 210A-C but it is contemplated that more than or less three rails and three guides may be used. In addition, in one embodiment, the rail guides 210A-C may provide a catch to prevent the upward movement of the top housing 30 beyond a certain point.

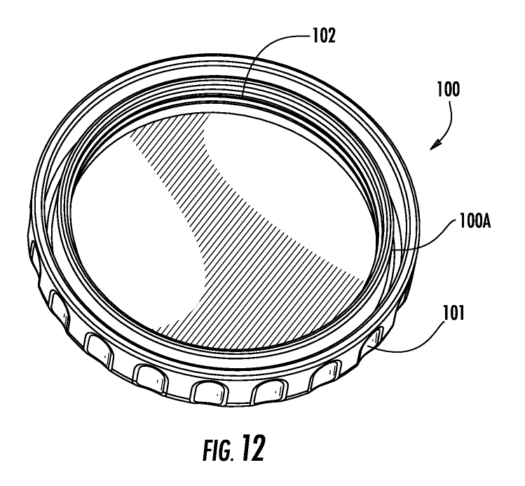

Referring to FIG. 11, a bottom view of the pill splitter 10 of FIG. 1 is shown. The bottom housing 40 has the defined opening 40C in the bottom portion 40B therein. The outer edge 40D of the opening 40C has a thickness smaller than the bottom housing 40. A male thread 40E is provided along an outer surface of the outer edge 40D. In addition, the volume defined within an interior of the bottom housing 40 is suitable for the storage of pills or other items.

Referring to FIG. 12, bottom cover 100 is threadably attached to the outer edge 40D of the opening 40C defined in the bottom housing 40. A female thread 102 is provided along the outer edge 100A of the bottom cover 100 for threadable attachment with the male thread 40E of the bottom housing 40. The bottom cover 100 is threadably attached so that pills or other items can be contained within from the interior of the bottom housing 40 and then easily accessed.

In use, the top housing 30 moves relative to the bottom housing 40 between a protected position, blade 110 unexposed, and a cutting position, blade 110 exposed. In the protected position, the top housing 30 resides in front of the blade 110 to prevent a user from contacting the blade 110. In the cutting position, which is only possible with protective lid 50 in closed position, the blade 110 is routed through the slot 33A in the top housing 30 thereby exposing a cutting edge thereof for cutting a pill.

It would be appreciated by those skilled in the art that various changes and modifications can be made to the illustrated embodiments without departing from the spirit of the present invention. All such modifications and changes are intended to be covered by the appended claims and the present invention.

What is claimed is:

1. A pill splitter, comprising:
a main body with a top housing and a bottom housing;
a blade mounted to the bottom housing;
the top housing, having a slot therein, movable relative to the bottom housing; the blade being movable between a protected position and a cutting position; and
a lid having an inner surface.

2. A pill splitter of claim 1, wherein the lid having an inner surface is hingedly connected to the top housing.

3. A pill splitter of claim 1, further comprising:
a pill impact member residing on the inner surface of the lid.

4. A pill splitter of claim 1, further comprising:
a locking arm having a flange and being movable between a blade locking and blade unlocking position;
a cam member, residing on the inner surface of the of the lid, releasably engageable with the flange through an aperture in the top housing;
whereby the locking arm is in a blade locking position when the cam member is not engaged with the flange and the locking arm is in a blade unlocking position when the cam member is engaged with the flange.

5. A pill splitter of claim 1, further comprising:
a pill seat formed within the top housing with slot positioned therethrough.

6. A pill splitter of claim 1, wherein the top housing is spring-biased relative to the bottom housing.

7. A pill splitter of claim 6, wherein the top housing is spring-biased to the bottom housing with springs.

8. A pill splitter of claim 4, wherein the locking arm is spring-biased.

9. A pill splitter of claim 1, further comprising:
a bottom cover removably attached to the bottom housing.

10. A pill splitter, comprising:
a main body with a top housing and a bottom housing;
a blade mounted to the bottom housing;
a means for controlling movement of the top housing relative to the bottom housing and the blade;
the top housing, having a slot therein, movable relative to the bottom housing and the blade between a protected position and a cutting position; in the protected position, the top housing residing in front of the blade preventing contact therewith and in the cutting position, when the means for preventing movement of the top housing relative to the blade is disengaged, the blade being routed through the slot in the top housing thereby exposing a cutting edge thereof for cutting a pill.

11. A pill splitter of claim 10, further comprising:
a lid hingedly connected to the housing.

12. A pill splitter of claim 10, wherein the lid provides a cushioning surface for cutting of a pill by the blade.

13. A pill splitter of claim 12, wherein the lid includes a wedge for receipt within an aperture defined within the top housing.

14. A pill splitter of claim 10, wherein the means for controlling movement of the top housing relative to the bottom housing is a locking arm.

15. A pill splitter of claim 14, wherein the locking arm contains a flange that engages the wedge to move the locking arm.

16. A pill splitter, comprising:
a main body with a top housing and a bottom housing;
a blade mounted to the bottom housing;
a locking arm mounted to the top housing to control movement of the top housing relative to bottom housing and relative to the blade;
the top housing, having a slot therein, movable relative to the bottom housing and the blade between a protected position and a cutting position; in the protected position, when the locking arm is in at rest position, the top housing resides in front of the blade preventing contact therewith and in the cutting position, when the locking arm is engaged, the blade being routed through the slot in the top housing thereby exposing a cutting edge thereof for cutting a pill.

17. A pill splitter of claim 16, further comprising:
a lid hingedly connected to the top housing.

18. A pill splitter of claim 17, wherein the lid provides a cushioning surface for cutting by the blade.

19. A pill splitter of claim 17, wherein the lid provides a wedge for receipt within an aperture defined within the top housing.
